(19) United States
(12) Patent Application Publication
(10) Pub. No.: US 2024/0108071 A1
(43) Pub. Date: Apr. 4, 2024

(54) AEROSOL PROVISION DEVICE

(71) Applicant: NICOVENTURES TRADING LIMITED, Londong (GB)

(72) Inventor: Patrick MOLONEY, London (GB)

(21) Appl. No.: 18/263,918

(22) PCT Filed: Feb. 10, 2022
(86) PCT No.: PCT/EP2022/053294

§ 371 Date: Aug. 2, 2023

(30) Foreign Application Priority Data
Feb. 10, 2021 (GB) 2101832.0

(51) Int. Cl. A24F 40/465; A24F 40/51; A24F 40/53; H05B 6/10

(52) U.S. Cl. CPC A24F 40/465; A24F 40/51; A24F 40/53; H05B 6/108

(57) ABSTRACT

An aerosol provision device is disclosed and can include one or more inductor coils wound around one or more stators, one or more susceptors and a power supply connected to the one or more inductor coils. The power supply is configured to provide an oscillating current to the one or more inductor coils.

### PRIORITY CLAIM

The present application is a National Phase entry of PCT Application No. PCT/EP2022/053294, filed Feb. 10, 2022, which claims priority from GB Application No. 2101832.0, filed Feb. 10, 2021, each of which is hereby fully incorporated herein by reference.

### TECHNICAL FIELD

The present disclosure relates to an aerosol provision device, an aerosol provision system, a method of generating an aerosol and a method of fabricating an aerosol provision device.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision devices, which cover the aforementioned devices or products, are known. Common aerosol provision devices use heaters to create an aerosol from a suitable medium which is then inhaled by a user. Often the medium used needs to be replaced or changed to provide a different aerosol for inhalation. It is known to use induction heating aerosol provision devices as heaters to create an aerosol from a suitable medium. An induction heating aerosol provision device generally consists of a magnetic field generating device for generating a varying magnetic field, and a susceptor or heating material which is heatable by penetration with the varying magnetic field to heat the suitable medium.

One problem with conventional arrangements is that the inductor arrangements are relatively large and hence are not particularly suited to miniaturization.

Another problem with conventional arrangements is that the inductor arrangement has a relatively low magnetic field strength.

Another problem with conventional arrangements is that the inductor arrangement provides a magnetic field which is confined to a particular region.

It is desired to provide an improved device with does not suffer from the above problems.

### SUMMARY

According to an aspect there is provided an aerosol provision device comprising:
one or more inductor coils wound around one or more stators;
one or more susceptors; and
a power supply connected to the one or more inductor coils, the power supply configured to provide an oscillating current to the one or more inductor coils.

The aerosol provision device may be arranged to enhance the magnetic field which is generated. Furthermore, the magnetic field may be arranged to be moved to different positions. The aerosol provision device is particularly suited to miniaturization and the inductor arrangement may have a relatively high magnetic field strength.

Optionally, the one or more inductor coils comprise one or more mandrel coils.

Optionally, the one or more mandrel coils may comprises single turn coil(s). Alternatively, the one or more mandrel coils may comprise a plurality of turns, for example, 2, 3, 4, 5, 6, 7, 8 or more turns.

Optionally, the one or more stators are laminated.

The one or more stators may be comprised of iron or ferrite, with a plurality of laminations there between.

Optionally, the aerosol provision device further comprises a flux concentrator.

Optionally, the flux concentrator comprises ferrite material and/or a continuous sheet or strip of ferrite material.

Optionally, the one or more inductor coils are configured to generate a varying magnetic field.

Optionally, the aerosol provision device further comprises one or more isolators disposed between the one or more inductor coils and the one or more stators.

Optionally, the one or more stators are arranged to enhance a magnetic field generated by the one or more inductor coils.

### FIELD

Optionally, the one or more susceptors are heatable by penetration with a varying magnetic

Optionally, the aerosol provision device comprises a non-combustible aerosol provision device.

According to another aspect there is provided an aerosol generating system comprising an aerosol provision device as described above and an article for use with an aerosol provision device.

Optionally, the article is for use with an aerosol provision device having one or more inductor coils wound around one or more stators, and wherein the one or more inductor coils are configured to generate a varying magnetic field and wherein the one or more susceptors are arranged and adapted to become heated by the varying magnetic field.

Optionally, the article comprises aerosol generating material.

Optionally, the aerosol generating material is provided either: (i) as a solid; (ii) as a liquid; (iii) in the form of a gel; (iv) in the form of a thin film substrate; (v) in the form of a thin film substrate having multiple regions; (vi) in the form of a thin film substrate having multiple regions, wherein at least two of the regions comprise aerosol generating material having different compositions.

According to another aspect there is provided a method of generating an aerosol comprising: providing an aerosol provision device as described above; and inserting an article for use with an aerosol provision device comprising aerosol generating material into the aerosol provision device.

According to another aspect there is provided an aerosol generating system comprising: an aerosol provision device comprising one or more inductor coils wound around one or more stators; one or more susceptors; and an article for use with an aerosol provision device located, in use, within the aerosol provision device.

According to another aspect there is provided an aerosol generating system comprising: an aerosol provision device; and an article for use with an aerosol provision device located, in use, within the aerosol provision device, wherein the article for use with an aerosol provision device comprises one or more inductor coils wound around one or more stators.

According to another aspect there is provided a method of generating an aerosol comprising: providing an aerosol provision device comprising one or more inductor coils wound around one or more stators and one or more susceptors, and one or more susceptors; inserting an article comprising aerosol generating material into the aerosol provision device; and providing an oscillating current to the one or more inductor coils.

According to another aspect there is provided a method of fabricating an aerosol provision device, the method comprising: forming a device housing together with one or more inductor coils wound around one or more stators, and one or more susceptors; and connecting a power supply to the one or more inductor coils, the power supply configured to provide an oscillating current to the one or more inductor coils.

The article may comprise a substantially flat article. The article may comprise a plurality of discrete portions of aerosol generating material. The article may comprise a substantially flat consumable.

### BRIEF DESCRIPTION OF THE DRAWINGS

Various embodiments will now be described, by way of example only, and with reference to the accompanying drawings, in which:

FIG. 1 shows a schematic view of an example of an inductor coil arrangement wrapped around a stator according to various embodiments;

FIG. 2 shows a schematic cross-sectional side view of an example of an aerosol provision device;

FIG. 3 shows a schematic perspective view of an example of an aerosol provision device;

FIG. 4 shows a schematic perspective view of an example of an aerosol provision device; and

FIG. 5A shows a plan view of a planar aerosol generating article, FIG. 5B shows an end-on view of the aerosol generating article and shows a plurality of susceptors embedded into the aerosol generating article and FIG. 5C shows a side view of the aerosol generating article and shows a plurality of susceptors embedded into the aerosol generating article.

### DETAILED DESCRIPTION OF THE DRAWINGS

As used herein, the term “aerosolizable material” or aerosol generating material includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, gelled sheet, powder, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

As used herein, the term “sheet” denotes an element having a width and length substantially greater than a thickness thereof. The sheet may be a strip, for example.

As used herein, the term “heating material” or “heater material” refers to material that is heatable by penetration with a varying magnetic field.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

A stator generally forms the stationary part of a rotary aerosol provision device, found in device such as electric generators and electric motors. A stator can concentrate magnetic flux e.g. magnetic flux produced by an inductor coil when an alternating current is passed through it, in use and makes a more powerful magnetic field. This magnetic field can be focused to an area of interest. In addition, the stator can direct the magnetic flux to its intended target.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

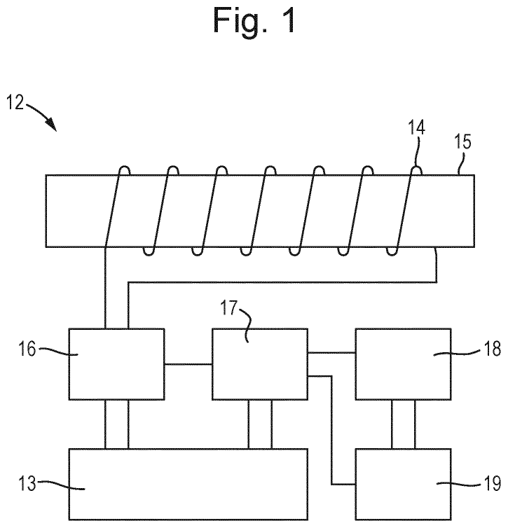

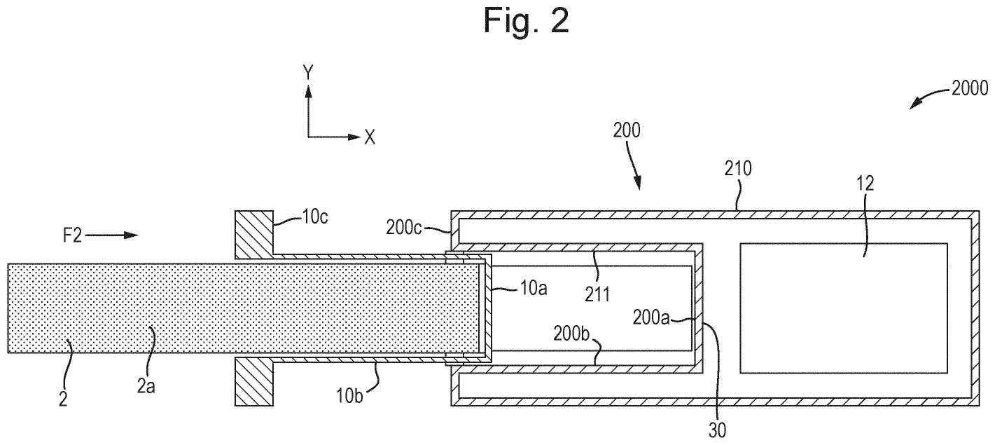

Referring to FIG. 1, there is shown a schematic view of an example of components 12 used in an aerosol provision device in order to generate a magnetic field. The components 12 are used with an aerosol provision device, such as the one described below with reference to FIG. 2. The components 12 comprise an electrical power source 13, an inductor coil 14, a stator 15, a device 16 for passing a varying electrical current, such as an alternating current, through the inductor coil 14, a controller 17, a user interface 18 for user-operation of the controller 17, and a temperature sensor 19.

Although there is shown only one inductor coil 14 and one stator 15, according to other arrangements there may be a plurality of inductor coils 14 wound around a plurality of respective stators 16. The plurality of inductor coils 14 wound around a plurality of stators 16 may be disposed in various locations of an aerosol provision device, depending on the characteristics and requirements of the device.

In arrangements where there are more than one inductor coils, it will be appreciated that the inductor coils, in some examples, may have at least one characteristic different from each other. For example, the first inductor coil may have at least one characteristic different from the second inductor coil, and so on. More specifically, in one example, the first inductor coil may have a different value of inductance than the second inductor coil. In other examples, first and second inductor coils may be of different lengths such that the first inductor coil is wound over a smaller section of the respective stator 15 than the second inductor coil. Thus, the first inductor coil may comprise a different number of turns than the second inductor coil (assuming that the spacing between individual turns is substantially the same). In yet another example, the first inductor coil may be made from a different material to the second inductor coil. In some examples, the inductor coils may be substantially identical.

The electrical power source 13 may comprise a rechargeable battery. The electrical power source 13 may be other than a rechargeable battery, such as a non-rechargeable battery, a capacitor, a battery-capacitor hybrid, or a connection to a mains electricity supply.

The inductor coil 14 may take any suitable form. For example, the inductor coil 14 may be in the form of a mandrel coil. The mandrel coil may comprise a single turn, or alternatively a plurality of turns e.g. 2, 3, 4, 5, 6, 7, 8 or 9 and more turns. Alternatively, the inductor coil 14 may be in the form of a helical coil of electrically-conductive material, such as copper. The inductor coil 14 is wound or wrapped around a portion of the stator 15. The inductor coil 14 may be wound around only a portion (i.e. not all) of the stator 15.

The stator 15 concentrates the magnetic flux produced by the inductor coil 14 in use and makes a more powerful magnetic field. Furthermore, the stator 15 helps to direct the magnetic flux to its intended target. The intended target as discussed below and with reference to FIGS. 2-4 is a susceptor 30,30a, which defines a heating region of an aerosol provision device. The susceptor 30,30a comprises heating material that is heatable by penetration with a varying magnetic field.

The stator 15 may have high magnetic permeability and low electrical conductivity. The latter helps prevent the generation of eddy currents in the stator 15 in use, which helps to prevent the stator 15 becoming heated in use.

The stator 15 may comprise, or is composed of, ferrite. The ferrite may, for example, contain iron oxide combined with nickel and/or zinc and/or manganese. The ferrite may have a low coercivity and be considered a “soft ferrite”, or have a high coercivity and be considered a “hard ferrite”. Example usable soft ferrites are manganese-zinc ferrite, with the formula MnZn(1-a)Fe2O4, and nickel-zinc ferrite, with the formula NiZn(1-a)Fe2O4. However, in respective variations the stator 15 may be made of a different material or materials.

For example, the stator 15 may comprise plural layers of electrically-conductive material that are isolated from one another by non-electrically-conductive material e.g. the stator 15 may be a laminated stator. That is, the stator 15 may have dozens, or even hundreds, of layers of electrically-conductive material that 20 are isolated from one another by non-electrically-conductive material.

The device 16 for passing a varying current through the inductor coil 14 may be electrically connected between the electrical power source 13 and the inductor coil 14. The controller 17 is also electrically connected to the electrical power source 13, and is communicatively connected to the device 16 to control the device 16. More specifically, the controller 17 is for controlling the device 16, so as to control the supply of electrical power from the electrical power source 13 to the inductor coil 14. The controller 17 may comprise an integrated circuit (IC), such as an IC on a printed circuit board (PCB).

In other arrangements, the controller 17 may take a different form. The apparatus may have a single electrical or electronic component comprising the device 16 and the controller 17. The controller 17 may be operated by user-operation of the user interface 18. The user interface 18 may be located at the exterior of the aerosol provision device into which the arrangement 12 is incorporated.

The user interface 18 may comprise a push-button, a toggle switch, a dial, a touchscreen, or the like. In other arrangements, the user interface 18 may be remote and connected to the rest of the apparatus wirelessly, such as via Bluetooth.

Operation of the user interface 18 by a user causes the controller 17 to cause the device 16 to cause an alternating electrical current to pass through the inductor coil 14, so as to cause the inductor coil 14 to generate an alternating magnetic field.

In the arrangements described below with reference to FIGS. 2 to 4, when an article 2 in which aerosol generating material 2a is disposed, is located in a heating zone 211 in proximity to the susceptor 30, the components of the aerosol provision device 12 and the susceptor 30 of the aerosol provision device are suitably positioned so that the alternating magnetic field produced by the inductor coil 14, is directed by the stator 15 so that the magnetic field penetrates the heating material of the susceptor 30, in turn heating the susceptor 30 by means of induction heating, which in turn heats the aerosol generating material 2a disposed inside of the article 2.

It will be apparent therefore, that using the arrangement 12 advantageously allows the focusing of a magnetic field to a small area. This is particularly advantageous if the physical patch or area of media (e.g. article 2) that needs to be heated is small or compact, a standard inductor coil arrangement is unlikely to heat the small area effectively. The stator 15 can direct and enhance the magnetic field to a small area of the susceptor 30 which in turn and heat a small area of medium to be heated, thus providing sufficient volume of aerosol for the end user.

In this way, the inductor coil 14 can be isolated from the susceptor 30, and placed in a location of the device that allows a compact form, as the inductor coil 14 does not need to be in close proximity to, or surrounding the susceptor 30, as the magnetic field produced by the inductor coil 14 can be manipulated and directed to an area of choice by the stator 15.

As described in the foregoing, when the heating material of the susceptor 30 is an electrically-conductive material, this may cause the generation of one or more eddy currents in the heating material. The flow of eddy currents in the heating material against the electrical resistance of the heating material causes the heating material to be heated by Joule heating. As mentioned above, when the heating material is made of a magnetic material, the orientation of magnetic dipoles in the heating material changes with the changing applied magnetic field, which causes heat to be generated in the heating material.

The temperature sensor 19 may be arranged to sense a temperature of the heating zone 211 in use. The temperature sensor 19 is communicatively connected to the controller 17, so that the controller 17 is able to monitor the temperature of the heating zone 211. In some arrangements, the temperature sensor 19 may be arranged to take an optical temperature measurement of the heating zone 211 or article 2.

The article 2 may comprise a temperature detector, such as a resistance temperature detector (RTD), for detecting a temperature of the article 2. The article 2 may further comprise one or more terminals connected, such as electrically-connected, to the temperature detector. The terminal(s) may be for making connection, such as electrical connection, with a temperature monitor of the aerosol provision device when the article is in the heating zone 211.

The controller 17 may comprise the temperature monitor. The temperature monitor of the device may thus be able to determine a temperature of the article 2 during use of the article 2 with the device.

It is contemplated that by ensuring that the heating material of the susceptor 30 has a suitable resistance, the response of the heating material to a change in temperature may be sufficient to give information regarding temperature inside the article 2. The temperature sensor 19 may then comprise a probe for analyzing the heating material.

On the basis of one or more signals received from the temperature sensor 19 or temperature detector, the controller 17 may cause the device 16 to adjust a characteristic of the varying or alternating electrical current passed through the inductor coil 14 as necessary, in order to ensure that the temperature of the heating zone 211 remains within a predetermined temperature range. The characteristic may be, for example, amplitude or frequency.

Within the predetermined temperature range, in use the aerosol generating material 2a material within an article 2 located in the heating zone 211 is heated sufficiently to volatilize at least one component of the aerosol generating material 2a without combusting the aerosol generating material 2a.

Accordingly, the controller 17, and the device as a whole, is arranged to heat the aerosol generating material 2a to volatilize the at least one component of the aerosol generating material 2a without combusting the aerosol generating material 2al.

The temperature range may be about 50° C. to about 300° C., such as between about 50° C. and about 250° C., between about 50° C. and about 150° C., between about 50° C. and about 120° C., between about 50° C. and about 100° C., between about 50° C. and about 80° C., or between about 60° C. and about 70° C. In some arrangements, the temperature range may be between about 170° C. and about 220° C. In other arrangements, the temperature range may be other than this range.

In some arrangements, the temperature sensor 19 may be omitted.

Referring to FIG. 2, there is shown a schematic cross-sectional side view of an example of an aerosol provision device 2000. The aerosol provision device 2000 comprises an apparatus 200 and a heating assembly which may be inserted into the apparatus 200. An article 2 comprising the aerosol generating material 2a is shown inserted within the aerosol provision device 2000.

The article 2 may comprise aerosol generating material 2a in the form of a rod. The article 2 may comprises a cover around the aerosol generating material 2a. The cover may encircle the aerosol generating material 2 and may help to protect the aerosol generating material 2a from damage during transport and use of the article 2. The cover may comprise an adhesive (not shown) that adheres overlapped free ends of the wrapper to each other. The adhesive helps prevent the overlapped free ends of the wrapper from separating. In other arrangements, the adhesive and/or the cover may be omitted. In still other arrangements, the article 2 may take a different form to any of those discussed above. The article 2 may comprise at least one filter (not shown). The article 2 comprises a downstream end and an upstream end, wherein the upstream end is insertable into the cavity 20 (see FIG. 2) of the heating assembly before the downstream end. The article 2 is configured such that a user draws a volatized component(s) of the aerosol generating material through the downstream end of the article 2.

The article 2 is insertable into the cavity 20 of the heating assembly in a direction of as indicated by F2. The insertion direction of the article 2 is the same as the insertion direction of the heating assembly into the aerosol provision device for heating the susceptor 30 of the heating assembly. The article 2 is therefore inserted into the heating assembly in an upstream direction. Equally, the heating assembly is inserted into the apparatus in an upstream direction.

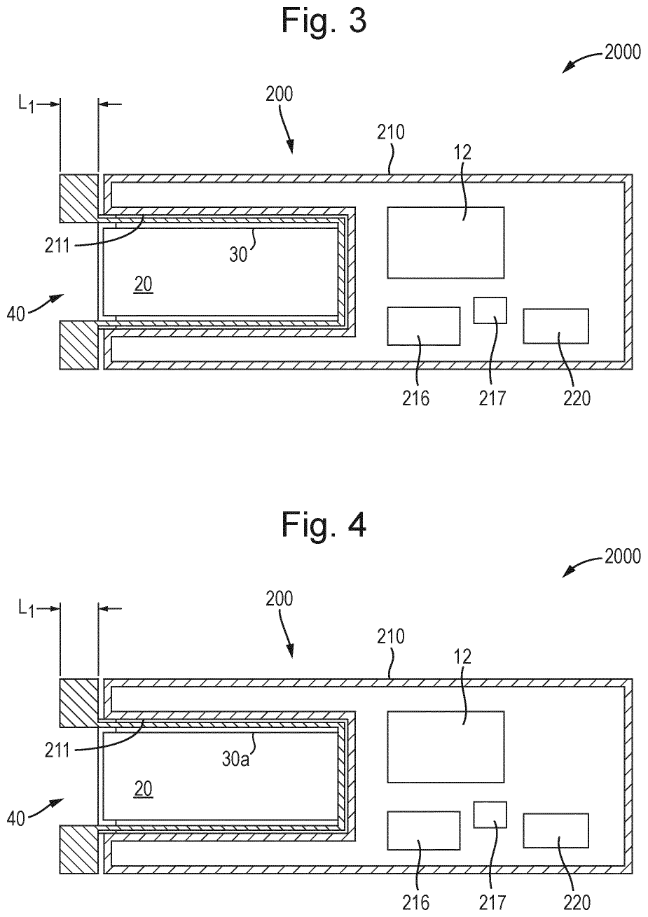

The article 2 comprises a mouth end and a distal end. The distal end is an upstream end and the mouth end is a downstream end. The distal end of the article 2a is first inserted into the cavity 20 (see FIG. 3) via the open end 40. The heating assembly therefore comprises a downstream end (for example, a distal end) and an upstream end (for example, a proximal end). When fully inserted into the cavity 20, the article 2 abuts the downstream end but protrudes away from the proximal end.

The heating assembly comprises the susceptor 30 for use in heating aerosol generating material. The apparatus 200 comprises the components 12 as described with reference to FIG. 1. The susceptor 30 is formed from heating material that is heatable by penetration with the varying magnetic field.

The apparatus 200 comprises a housing 210 defining a heating zone 211. The heating zone 211 is a chamber into which the heating assembly is insertable. The chamber of the apparatus 200 is therefore a receiving portion. The chamber may comprise a surface that is shaped complementarily to a mating surface of the heating assembly.

The heating assembly may alternatively form part of the housing and is not removable. Instead, only the article 2 containing aerosol generating material 2a is inserted into the aerosol provision device 2000 so that it is disposed with a heating zone 211 of the aerosol provision device 2000.

As shown in FIG. 2, the article 2 may be first inserted into the heating assembly before the heating assembly and article 2 are inserted as one into the heating zone 211 of the apparatus 200. However, the heating assembly may be first inserted into the heating zone 211 of the apparatus 200 before the article 2 is inserted into the cavity 20 (see FIG. 3) of the heating assembly. The combined heating assembly and article 2 are inserted in a direction X which corresponds to a longitudinal dimension of the apparatus. Once inserted, the heating assembly may be restrained by the apparatus 200 so that the heating assembly is immoveable relative to the apparatus 200 in a direction Y, which is a direction perpendicular to the direction X.

In other examples, the heating assembly may take a different form, with the susceptor 30 or multiple susceptors located in different location with respect to the article 2 e.g. having a susceptor that encloses all sides of the heating zone 211.

In this example, the heating assembly is shown with coupling regions, for example a first surface 10a, second surface 10b and a third surface 10c. Each coupling region may be referred to as a coupler. Although a single coupler 10a,10b,10c may be needed to engage with a respective retainer 200a,200b,200c of the apparatus, a plurality of couplers may be provided. The couplers 10a,10b,10c may be suitable for restraining movement, e.g. longitudinal movement, of the heating assembly relative to the apparatus 200 when the heating assembly is installed in the apparatus 200. The couplers 10a,10b,10c and/or retainers 200a,200b,200c therefore act as a blocking member to block a movement of the heating assembly and retain the heating assembly in the apparatus 200 relative to at least one direction of movement, e.g. movement in the direction X and/or direction Y. Such directional movement may be axial movement which is movement in an axial direction of the heating assembly corresponding to direction X. The couplers 10a,10b,10c and/or retainers 200a,200b,200c may resist translational movement of the heating assembly corresponding to direction Y.

Alternatively, or additionally, each coupler 10a,10b,10c and/or each respective retainer 200a,200b,200c may resist rotation of the heating assembly relative to the apparatus 200 about the longitudinal axis.

The couplers 10a,10b,10c and/or retainers 200a,200b,200c may be an abutment member for abutting at least one surface of the respective apparatus 200 or heating assembly. The couplers 10a,10b,10c and/or retainers 200a,200b,200c may limit the extent of movement of the heating assembly.

The couplers 10a,10b,10c may be blockable by a corresponding abutment member or portion of the apparatus 200 to prevent movement of the heating assembly in the apparatus 200, particularly when an article containing aerosol generating material is removed from the heating assembly.

Referring to FIG. 3 there is shown a cross-sectional side view of an example of an aerosol provision device 2000 according to an arrangement. The aerosol provision device 2000 comprises apparatus 200 and a heating assembly insertable into the apparatus 200, wherein the heating assembly comprises a susceptor 30 for use in heating aerosol generating material to volatilize at least one component of the aerosol generating material. The apparatus 200 comprises the components 12 as described with reference to FIG. 1, in which the device 16 is configured to pass a varying electric field through the inductor coil, which produces a varying magnetic field. The magnetic field penetrates the stator 15 and is enhanced and directed towards the susceptor 30.

The susceptor 30 is formed from heating material that is heatable by penetration with the varying magnetic field, which in turn heats the article containing aerosol generating material.

More specifically, the apparatus 200 comprises a housing 210. A mouthpiece (not shown) may be connected to the housing 210 and/or the heating assembly. The mouthpiece may be made of any suitable material, such as a plastics material, cardboard, cellulose acetate, paper, metal, glass, ceramic, or rubber. The mouthpiece may define a channel therethrough. The mouthpiece may be locatable relative to the housing 210 so as to cover an opening into a heating zone 211 or a cavity 20 of the heating assembly when the heating assembly is inserted into the heating zone 211. When the mouthpiece is so located relative to the housing 210, the channel of the mouthpiece is in fluid communication with the heating zone 211. In use, the channel acts as a passageway for permitting volatilized material to pass from aerosol generating material of an article inserted in the heating zone 211 to an exterior of the apparatus 200. The mouthpiece of the apparatus 200 may be releasably engageable with the housing 210 so as to connect the mouthpiece to the housing 210. In other arrangements, the mouthpiece and the housing 210 may be permanently connected, such as through a hinge or flexible member. In some arrangements, such as arrangements in which the article itself comprises a mouthpiece, the mouthpiece of the apparatus 200 may be omitted.

The apparatus 200 may define an air inlet (not shown) that fluidly connects the heating zone 211 with the exterior of the apparatus 200. Such an air inlet may be defined by the housing 210 and/or by an optional mouthpiece. A user may be able to inhale the volatilized component(s) of the aerosol generating material by drawing the volatilized component(s) through the channel of the optional mouthpiece. As the volatilized component(s) are removed from an article, air may be drawn into the heating zone 211 via the air inlet of the apparatus 200.

The aerosol provision device 2000 comprises an apparatus 200 which comprises components 12 as shown and described with reference to FIG. 1 e.g. an electrical power source 13, an inductor coil 14, a device 16 for passing a varying electrical current, such as an alternating current, through the inductor coil 14, a controller 17, and a user interface 18 for user-operation of the controller 17. The apparatus 200 further comprises a temperature sensor 19 for sensing a temperature of the heating zone 211.

The apparatus 200 further comprises a sensor 216 to detect information about a use of the apparatus 200 when the apparatus 200 is coupled to the heating assembly. The information may be stored in a memory 217 of the apparatus. The memory may comprise a data storage device. The sensor 216 may further perform an action when the information meets a predetermined criterion. In some arrangements, the sensor 216 may provide an indication when the information meets a predetermined criterion. The predetermined criterion may be a total power on time. For example, the information detected by the sensor 216 may be an elapsed time. A total power on time therefore corresponds to a detected time elapsed from the apparatus 200 being turned ON. The apparatus 200 may be considered turned ON when the susceptor 30 is first penetrated by a varying magnetic field. Alternatively, or additionally, the sensor 216 may detect information about a number of sessions of use of the apparatus. A single session may comprise a predetermined number of draws on an article by a user. Alternatively, a single session may comprise a predetermined time from when the user first draws on an article or when the susceptor 30 is first activated.

The controller 17 may be configured to control the device 16 based on the information. The information may be analyzed by an analyzer 220 of the apparatus 200. The analyzer 220 receives information from at least one sensor 216, or temperature sensor 19 and the information is sent to the controller 17 to determine how to control the inductor 14 and stator 15 arrangement based on the information analyzed by the analyzer 220. For example, the heating device 16 may be configured to measure a number of sessions, which may be a number of activations of the power on button or a puff sensor, or may be configured to measure a total power used or power on time. Once a threshold is reached, the heating device 16 may indicate to a user that the susceptor 30 needs changing and/or the heating device 16 may not allow the susceptor 30 to be heatable.

The electrical power source 13 of this arrangement is a rechargeable battery. In other arrangements, the electrical power source 13 may be other than a rechargeable battery, such as a non-rechargeable battery, a capacitor, a battery-capacitor hybrid, or a connection to a mains electricity supply.

The inductor coil 14 may take any suitable form. In this arrangement, the inductor coil 14 is a mandrel coil. As described above, the inductor coil 14 may be wrapped around a stator 15 such that the stator 15 concentrates the magnetic flux produced by the inductor coil 14 in use and makes a more powerful magnetic field. As a result, the aerosol provision device 2000 can be made more compactly, e.g. such that it can heat smaller articles that may comprise small amounts of gels or any other suitable aerosol generating material, as the magnetic flux can be concentrated on the susceptor 30 to heat a small or specific area.

The stator may be made of iron, for example. In some arrangements, the stator 15 may extend only partially along the length of the inductor coil 14, so as to concentrate the magnetic flux only in certain regions. In some arrangements, the inductor coil 14 may be a flat coil. That is, the inductor coil 14 may be a two-dimensional spiral.

Referring to FIG. 4 there is shown a schematic perspective view of an example of a system 2000. The system 2000 comprises apparatus 200 and a heating assembly insertable into the apparatus wherein the heating assembly comprises a susceptor 30a for use in heating aerosol generating material. Features in FIG. 4 with the same reference numeral as FIG. 3 are the same. The difference between FIGS. 3 and 4 is that the susceptor 30 in FIG. 3 is only on one side of the heating assembly, whereas, in FIG. 4 the susceptor 30a is tubular.

The heating susceptor 30a shown in FIG. 4 is hollow. The susceptor 30a may be formed from a sheet. The susceptor 30a may be a single piece. The sheet may have a constant thickness. The susceptor 30a may have a constant cross-sectional shape. For example, the susceptor 30a may be substantially circular, square or rectangular in cross-section along a length of the susceptor 30a. A length of the susceptor 30a may be greater than a width of the susceptor 30a perpendicular to the length. In other arrangements, the length and width may be substantially equal. In yet further arrangements, the susceptor 30a may have a length smaller than a width.

The susceptor 30a shown in FIG. 4 is generally cylindrical with a substantially circular cross section. In other arrangements, the susceptor 30a may have an oval or elliptical cross section or may be other than cylindrical. In some arrangements, the susceptor 30a may have a polygonal, quadrilateral, rectangular, square, triangular, star-shaped, or irregular cross section, for example. In this arrangement, the susceptor 30a is a tube. The susceptor 30a comprises a chamber which is a hollow inner region of the tube. The chamber 20 may correspond to a heating zone 211 when the susceptor 30a is arranged in an apparatus 200. The chamber 20 is configured for receiving the aerosol generating material.

The susceptor 30a may comprise an extruded member formed by an extrusion process. The extruded member may be tubular so that a cross section of the body is endless with no joins.

The susceptor 30a in FIG. 4 is open at both a first end and a second end that is opposite the first end. The first end therefore comprises a first opening and the second end comprises a second opening. The first and second openings may be axially aligned on a longitudinal axial axis. The first and second openings may be parallel to one another.

Aerosol generating material may be insertable into the cavity 20 through an opening 40. Therefore, the opening 40 is the initial point of passage of aerosol generating material into the cavity 20. Longitudinal wall(s) of the susceptor 30a extend between the first end and the second end of the susceptor 30a. Alternatively, the susceptor 30a may have a single open end.

A thickness of the susceptor 30a may be less than 100 μm. The thickness may be between 10 μm and 40 μm. The thickness may be between 20 μm and 30 μm. The thickness may be about 25 μm.

The one or more removable susceptors may comprise one or more ferritic elements. The one or more terrific elements may comprise a ceramic material. The one or more ferritic elements may be formed by mixing iron (III) oxide (Fe₂O₃) with one or more additional metallic elements to form a mixture and then heating the mixture to form a ceramic. The one or more additional metallic elements may be selected from the group comprising: (i) barium; (ii) manganese; (iii) nickel; and (iv) zinc. The terrific element may be electrically non-conductive. The ferritic element may comprise an electrical insulator. The terrific element may be either: (i) magnetizable; (ii) ferromagnetic; or (iii) ferrimagnetic.

The one or more inductor coils may be arranged to generate a varying magnetic field and the one or more susceptors may be arranged to become heated by the varying magnetic field.

The one or more susceptors may be arranged and adapted to heat not burn aerosol generating material provided in the article for use with an aerosol provision device.

The one or more susceptors may be arranged and adapted to generate aerosol from aerosol generating material provided in the article for use with an aerosol provision device.

The article for use with an aerosol provision device may comprise aerosol generating material and may be provided: (i) as a solid; (ii) as a liquid; (iii) in the form of a gel; (iv) in the form of a thin film substrate; (v) in the form of a thin film substrate having multiple regions; or (vi) in the form of a thin film substrate having multiple regions, wherein at least two of the regions comprise aerosol generating material having different compositions.

An aerosol provision device is disclosed comprising one or more inductor coils. The aerosol provision device may be arranged and adapted: (i) to receive an article for use with an aerosol provision device which is located, in use, within the aerosol provision device; and (ii) to receive one or more removable susceptors which are located, in use, within the aerosol provision device.

A method of generating an aerosol is disclosed comprising providing an aerosol provision device comprising one or more inductor coils, locating an article for use with an aerosol provision device within the aerosol provision device and locating one or more removable susceptors within the aerosol provision device.

An aerosol provision system is disclosed comprising an aerosol provision device and an article for use with an aerosol provision device located, in use, within the aerosol provision device. The article for use with an aerosol provision device may comprise one or more inductor coils and/or one or more susceptors.

The one or more susceptors may comprise one or more ferritic elements. The one or more ferritic elements may comprise a ceramic material. The one or more ferritic elements may be formed by mixing iron (III) oxide (Fe₂O₃) with one or more additional metallic elements to form a mixture and then heating the mixture to form a ceramic. The one or more additional metallic elements may be selected from the group comprising: (i) barium; (ii) manganese; (iii) nickel; and (iv) zinc.

The one or more ferritic elements may be electrically non-conductive. The one or more ferritic elements may be an electrical insulator. The one or more terrific elements may be either: (i) magnetizable; (ii) ferromagnetic; or (iii) ferrimagnetic. The one or more inductor coils may be arranged to generate a varying magnetic field and the one or more susceptors may be arranged to become heated by the varying magnetic field.

The one or more susceptors may be arranged and adapted to heat aerosol generating material provided in the article for use with an aerosol provision device. The one or more susceptors may be arranged and adapted to generate aerosol from aerosol generating material provided in the article for use with an aerosol provision device. The aerosol provision device may comprise a non-combustible aerosol provision device.

A method of fabricating an aerosol provision device is also disclosed comprising forming one or more inductor coils and one or more susceptors within the aerosol provision device, wherein at least one of the susceptors may comprise one or more ferritic elements.

A method of fabricating a susceptor is also disclosed comprising forming one or more removable susceptors which are located, in use, within an aerosol provision device and which may be readily removed from the aerosol provision device.

A method of fabricating an article for use with a non-combustible aerosol provision device is also disclosed comprising forming an article for use with an aerosol provision device which is located, in use, within an aerosol provision device, wherein the article for use with a non-combustible aerosol provision device may comprise one or more inductor coils and/or one or more susceptors.

The article 2 comprises a consumable article or an article for use with a non-combustible aerosol provision device. Once all, or substantially all, of the volatilizable component(s) of the aerosol generating material 2a in the article 2 has/have been spent, the user may remove the article 2 from the cavity 20 of the heating assembly and dispose of the article 2. The user may subsequently re-use the apparatus 200 with another of the articles 2. However, the article 2 may be non-consumable relative to the heating assembly. That is, the heating assembly and the article 2 may be disposed of together once the volatilizable component(s) of the aerosol generating material 2a has/have been spent.

The article 2 may be sold, supplied or otherwise provided separately from the apparatus 200 with which the article 2 is usable. The apparatus 200 and one or more of the articles 2 may be provided together as a system, such as a kit or an assembly, possibly with additional components, such as cleaning utensils.

The aerosol provision device may comprise a hybrid aerosol provision device to generate aerosol using a combination of aerosol generating materials, one or a plurality of which may be heated. Each of the aerosol generating materials may be, for example, in the form of a solid, liquid or gel and may or may not contain nicotine. The hybrid aerosol provision device may comprise a liquid or gel aerosol generating material and a solid aerosol generating material. The solid aerosol generating material may comprise, for example, tobacco or a non-tobacco product.

The aerosol provision device may comprise an aerosol provision device and an article for use with the aerosol provision device. However, it is envisaged that articles which themselves comprise a means for powering an aerosol generating component may themselves form the aerosol generating aerosol provision device. The aerosol provision device may comprise a power source and a controller. The power source may, for example, be an electric power source.

The article for use with the aerosol provision device may comprise an aerosol generating material, an aerosol generating component, an aerosol generating area, a mouthpiece, and/or an area for receiving aerosol generating material. The aerosol generating component may comprise a heater capable of interacting with the aerosol generating material so as to release one or more volatiles from the aerosol generating material to form an aerosol.

The substance to be delivered may be an aerosol generating material. Aerosol generating material, which also may be referred to herein as aerosolizable material, is material that is capable of generating aerosol, for example when heated, irradiated or energized in any other way. Aerosol generating material may, for example, be in the form of a solid, liquid or gel which may or may not contain nicotine and/or flavorants.

The aerosol provision device and the inductor coil find particular utility when generating aerosol from a substantially flat article, in particular an article comprising a substantially flat consumable.

The substantially flat consumable may be provided as either an array or a circular format. Other arrangements are also contemplated.

The substantially flat consumable may be provided with a plurality of discrete portions of aerosol generating material. The plurality of discrete portions of aerosol generating material may be arranged in an array or grid-like configuration. The plurality of discrete portions of aerosol generating material may be arranged in a circular pattern.

In some arrangements e.g. wherein the substantially flat consumable is provided in the form of an array, multiple heating regions may be provided. For example, one heating region may be provided per portion, pixel or zone/segment of the consumable.

In other arrangements, the substantially flat consumable may be rotated such that a segment of the consumable may be heated by a similar shaped heater i.e. the heater has a similar shape to the shape of the consumable. According to this arrangement a single heating region may be provided.

The substantially flat consumable may be moved in one or more direction with respect to a heating region.

In particular, the inductor coil may be provided as part of a non-combustible aerosol provision device which is arranged to heat-not-burn a consumable as part of an aerosol provision device. In particular, the consumable may comprise a plurality of discrete portions of aerosol generating material, The consumable may comprise a support on which the aerosol generating material is provided. The support functions as a support on which the aerosol generating material forms, easing manufacture. The support may provide tensile strength to the aerosol generating material, easing handling. In some cases, the plurality of discrete portions of aerosol generating material are deposited on such a support. In some cases, the plurality of discrete portions of aerosol generating material is deposited on such a support. In some cases, the discrete portions of aerosol generating material are deposited on such a support such that each discrete portion may be heated and aerosolized separately. The consumable may comprise a plurality of discrete portions of aerosol generating material, the discrete portions provided on a support and each of the discrete portions comprising less than 15 mg of water.

Suitably, the discrete portions of aerosol generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract.

In some cases, the support may be non-magnetic.

In some cases, the support may be magnetic. In one particular case, the support may be a paper-backed foil. The paper layer may abut the aerosol generating material and the properties discussed in the previous paragraphs are afforded by this abutment. The foil backing is substantially impermeable, providing control of the aerosol flow path. A metal foil backing may also serve to conduct heat to the aerosol generating material.

In some cases, the support is formed from or comprises metal foil, such as aluminum foil. A metallic support may allow for better conduction of thermal energy to the aerosol generating material. Additionally, or alternatively, a metal foil may function as a susceptor in an induction heating aerosol provision device. The support may comprise a metal foil layer and a support layer, such as cardboard.

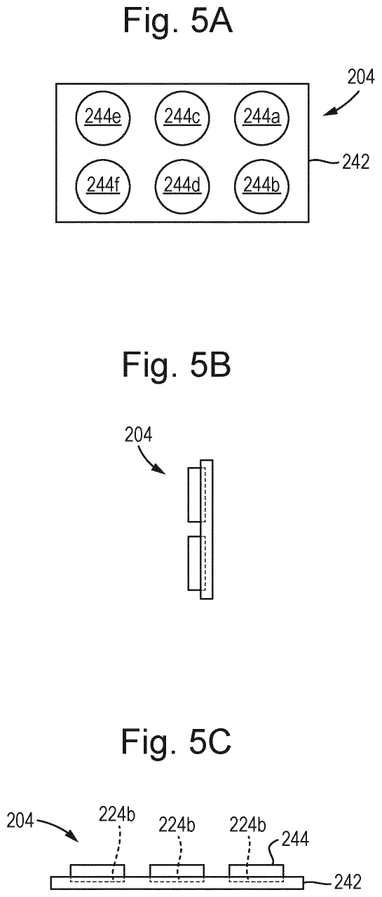

Reference is made to FIGS. 5A-5C. A consumable or aerosol generating article 204 for use with an aerosol provision device may be provided wherein the aerosol generating article 204 comprises a planar aerosol generating article 204. The planar aerosol generating article 204 may comprise a carrier component 242, one or more susceptor elements 224b and one or more portions of aerosol generating material 244a-f as shown and described in more detail with reference to FIGS. 5A-5C.

FIG. 5A shows a top-down view of an aerosol generating article 204, FIG. 5B shows an end-on view along the longitudinal (length) axis of the aerosol generating article 204 and FIG. 5C shows a side-on view along the width axis of the aerosol generating article 204.

The one or more susceptor elements 224b may be formed from aluminum foil, although it should be appreciated that other metallic and/or electrically conductive materials may be used in other implementations. As seen in FIG. 5C, the carrier component 242 may comprise a number of susceptor elements 224b which correspond in size and location to the discrete portions of aerosol generating material 244a-f disposed on the surface of the carrier component 242. That is, the susceptor elements 224b may have a similar width and length to the discrete portions of aerosol generating material 244a-f.

The susceptor elements 224b are shown embedded in the carrier component 242. However, the susceptor elements 224b may be placed or located on the surface of the carrier component 242. According to another arrangement a susceptor may be provided as a single layer substantially covering the carrier component 244. The aerosol generating article 204 may comprise a substrate or support layer, a single layer of aluminum foil which acts as a susceptor and one or more regions of aerosol generating material 244 deposited upon the aluminum foil susceptor layer.

An array of induction heating coils may be provided to energize the discrete portions of aerosol generating material 244. However, a single induction coil may be provided and the aerosol generating article 204 may be configured to move relative to the single induction coil. Accordingly, there may be fewer induction coils than discrete portions of aerosol generating material 244 provided on the carrier component 242 of the aerosol generating article 204, such that relative movement of the aerosol generating article 204 and induction coil(s) is required in order to be able to individually energize each of the discrete portions of aerosol generating material 244.

Alternatively, a single induction coil may be provided and the aerosol generating article 204 may be rotated relative to the single induction coil.

Although the above has described implementations where discrete, spatially distinct portions of aerosol generating material 244 are deposited on a carrier component 242, it should be appreciated that in other implementations the aerosol generating material 244 may not be provided in discrete, spatially distinct portions but instead be provided as a continuous sheet, film or layer of aerosol generating material 244. In these implementations, certain regions of the sheet of aerosol generating material 244 may be selectively heated to generate aerosol in broadly the same manner as described above.

The aerosol generating article 204 may comprise a disc shaped or circular consumable.

In order to address various issues and advance the art, this disclosure shows by way of illustration various embodiments in which that which is claimed may be practiced. The advantages and features of the disclosure are of a representative sample of embodiments only, and are not exhaustive and/or exclusive. They are presented only to assist in understanding and to teach that which is claimed. It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An aerosol provision device comprising:
one or more inductor coils wound around one or more stators;
one or more susceptors; and
a power supply connected to the one or more inductor coils, the power supply configured to provide an oscillating current to the one or more inductor coils.

2. The aerosol provision device as claimed in claim 1, wherein the one or more inductor coils comprises one or more mandrel coils.

3. The aerosol provision device as claimed in claim 2, wherein the one or more mandrel coils comprises a single turn coil.

4. The aerosol provision device as claimed in claim 2, wherein the one or more mandrel coils comprise a plurality of turns.

5. The aerosol provision device as claimed in claim 1, wherein the one or more stators are laminated.

6. The aerosol provision device as claimed in claim 1, further comprising a flux concentrator.

7. The aerosol provision device as claimed in claim 6, wherein the flux concentrator comprises at least one of a ferrite material or a continuous sheet or strip of ferrite material.

8. The aerosol provision device as claimed in claim 1, wherein the one or more inductor coils are configured to generate a varying magnetic field.

9. The aerosol provision device as claimed in claim 1, further comprising one or more isolators disposed between the one or more inductor coils and the one or more stators.

10. The aerosol provision device as claimed in claim 1, wherein the one or more stators are arranged to enhance a magnetic field generated by the one or more inductor coils.

11. The aerosol provision device as claimed in claim 1, wherein the one or more susceptors are heatable by penetration with a varying magnetic field.

12. The aerosol provision device as claimed in claim 1, wherein the aerosol provision device comprises a non-combustible aerosol provision device.

13. An aerosol provision system comprising:
the aerosol provision device as claimed in claim 1; and
an article for use with the aerosol provision device.

14. The aerosol provision system as claimed in claim 13, wherein the one or more inductor coils of the aerosol provision device are configured to generate a varying magnetic field and wherein the one or more susceptors are arranged to become heated by the varying magnetic field.

15. The aerosol provision system as claimed in claim 13, wherein the article comprises aerosol generating material.

16. The aerosol provision system as claimed in claim 15, wherein the aerosol generating material is provided either: as a solid; as a liquid; in the form of a gel; in the form of a thin film substrate; in the form of a thin film substrate having multiple regions; or in the form of a thin film substrate having multiple regions, wherein at least two of the multiple regions comprise aerosol generating material having different compositions.

17. A method of generating an aerosol comprising:
providing aerosol provision device as claimed in claim 1; and
inserting an article for use with the aerosol provision device and comprising aerosol generating material into the aerosol provision device.

18. (canceled)

19. An aerosol provision system comprising:
an aerosol provision device; and
an article for use with the aerosol provision device located, in use, within the aerosol provision device, wherein the article for use with the aerosol provision device comprises one or more inductor coils wound around one or more stators.

20. The method of claim 17, further comprising providing an oscillating current to the one or more inductor coils.

21. (canceled)
